(19) United States
(12) Patent Application Publication
(10) Pub. No.: US 2006/0144606 A1
(43) Pub. Date: Jul. 6, 2006

(54) Meter readout visor

(76) Inventor: Charlie H. Williams JR., Longview, TX (US)

Correspondence Address: The Law Office of Stephen R. Loe, P.O. Box 649, Frisco, TX, 75034, US

(21) Appl. No.: 11/030,220

(22) Filed: Jan. 6, 2005

(51) Int. Cl. H02G 3/08

(52) U.S. Cl. 174/50

(57) ABSTRACT

A meter visor for improving the readability of the meter readout on a meter is provided. In one embodiment, the meter visor includes a top surface and aback surface. The top surface extends from a front surface of a meter and situated above the meter readout. The back portion of the meter visor provides a surface by which the meter visor is affixed to a surface of the meter. Thus, the extended portion of the meter readout at least partially protects the meter from, for example, rain, thereby preventing or at least inhibiting the collection of water droplets on the meter readout which would otherwise inhibit the readability of the meter readout by a meter reader.

### BACKGROUND OF THE INVENTION

1. Technical Field

The present invention relates generally to meter readouts and, more specifically, to devices for enhancing the readability of meter readouts.

2. Description of Related Art

Meters are utilized in numerous applications in industry, commercial, and residential settings to measure all sorts of quantities, such as, for example, oil flow, gas flow, electric consumption, and water flow, to name a few. Many meters are located outdoors because, for example, there is no building nearby to the substance measured by the meter or because, for example, the meter reader does not have access to the building proximate to the meter (e.g., residential electric and gas meter readers do not have access to the residences to which the meters correspond).

Often times, the meter reader must or prefers to read the meter from a distance due, for example, the inaccessibility of the meter or to time constraints imposed by the necessity of reading numerous meters in various locations. Normally reading the meter from a distance poses no problem other than perhaps the necessity of utilizing binoculars or other vision enhancing devices. However, occasionally, problems reading the meter due arise due to poor weather and/or light conditions.

With reference now to FIG. 1, a pictorial diagram illustrating a meter reader reading a meter from a distance in accordance with the prior art is depicted in order to help illuminate the problems sometimes face by meter readers. In the present example, the meter 102 contains a digital readout 104 which may be, for example, a light emitting diode (LED) display, a liquid crystal display (LCD). However, the type of display is not crucial to the illustration. The meter is 102 is connected via connector 106 to a point where a measurement is made which in this case is gas flow through an gas pipe 108.

In a typical scenario for reading a meter 102, for example, a meter at an gas well site as depicted in FIG. 1, the meter 102 may be located in a remote site away from a town or city or otherwise situated such that a meter reader 112 must drive a vehicle 110 to the location. The meter reader 112 preferably would like to remain in the vehicle 110 or merely step out of the vehicle 112 as depicted in FIG. 1 to read the meter and would like to avoid the trouble and time necessary to get out of the vehicle 112 and physically approach the meter 102 on foot.

Under ideal conditions, it is easy for the meter reader to determine that the number indicated on the meter readout or display 104 is 97586451 as can be seen more clearly in FIG. 2 which depicts a meter 102 in greater clarity. However, under less than ideal conditions, reading a meter readout is not so simple. For example, FIG. 3 depicts meter 102 during a rain storm. The display 104 is obscured by water droplets 302, thus making it difficult or impossible to read the meter readout 104. A display that is obscured like display 104 would necessitate a meter reader to leave the vehicle and walk to the meter, possibly through mud and rain, in order to read the meter. This takes time, which costs money. Additionally, there is the risk of slipping and falling and injuring oneself.

Rain and water droplets are, of course, just one of many conditions that could cause the display 104 to be obscured. For example, dew could form on the display 104 resulting in much the same conditions of poor readability as rain.

Therefore, it would be desirable to have a device which minimizes the effects of poor weather and/or light conditions on reading a meter, thereby improving the ability of a meter reader to read the meter even during or after poor weather and/or lighting conditions.

### SUMMARY OF THE INVENTION

The present invention provides a meter visor for improving the readability of the meter readout on a meter. In one embodiment, the meter visor includes a top surface and aback surface. The top surface extends from a front surface of a meter and situated above the meter readout. The back portion of the meter visor provides a surface by which the meter visor is affixed to a surface of the meter. Thus, the extended portion of the meter readout at least partially protects the meter from, for example, rain, thereby preventing or at least inhibiting the collection of water droplets on the meter readout which would otherwise inhibit the readability of the meter readout by a meter reader.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial diagram illustrating a meter reader reading a meter from a distance in accordance with the prior art;

FIG. 2 depicts a pictorial diagram showing the prior art meter in greater detail;

FIG. 3 depicts a pictorial diagram of the prior art meter with the display obscured by water droplets;

FIG. 4A depicts a pictorial diagram illustrating a head on view of an exemplary meter with a meter visor protecting the meter readout in accordance with one embodiment of the present invention;

FIG. 4B depicts a pictorial diagram illustrating a side view of a meter depicted in FIG. 4A with an exemplary meter visor covering the display in accordance with one embodiment of the present invention;

FIGS. 5A-5D depict schematic diagrams illustrating an exemplary meter visor from various viewpoints in accordance with one embodiment of the present invention;

FIGS. 6A and 6B depict diagrams illustrating a meter having an analog readout and a curved meter visor in accordance with one embodiment of the present invention; and

FIGS. 7A and 7B depict diagrams illustrating a meter with a sloped meter visor protecting the meter readout display in accordance with one embodiment of the present invention.

### DETAILED DESCRIPTION OF THE PREFERRED EMBODIMENT

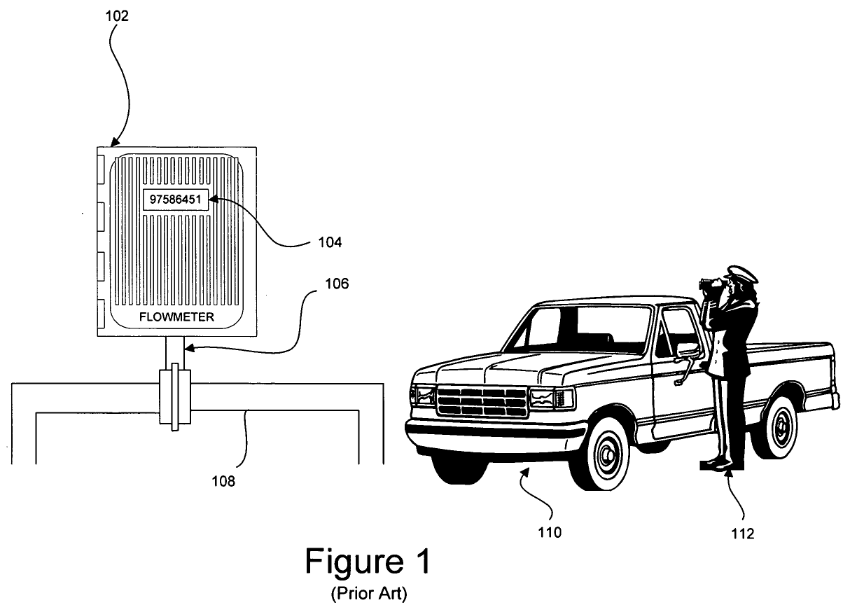

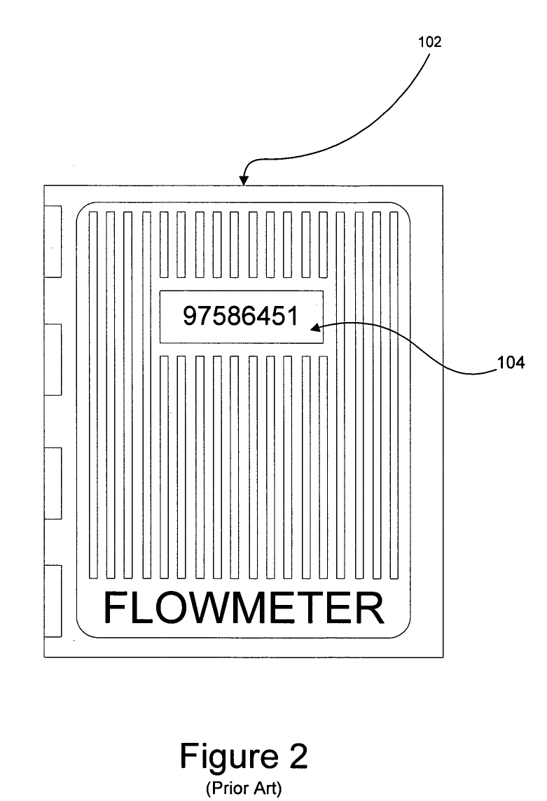

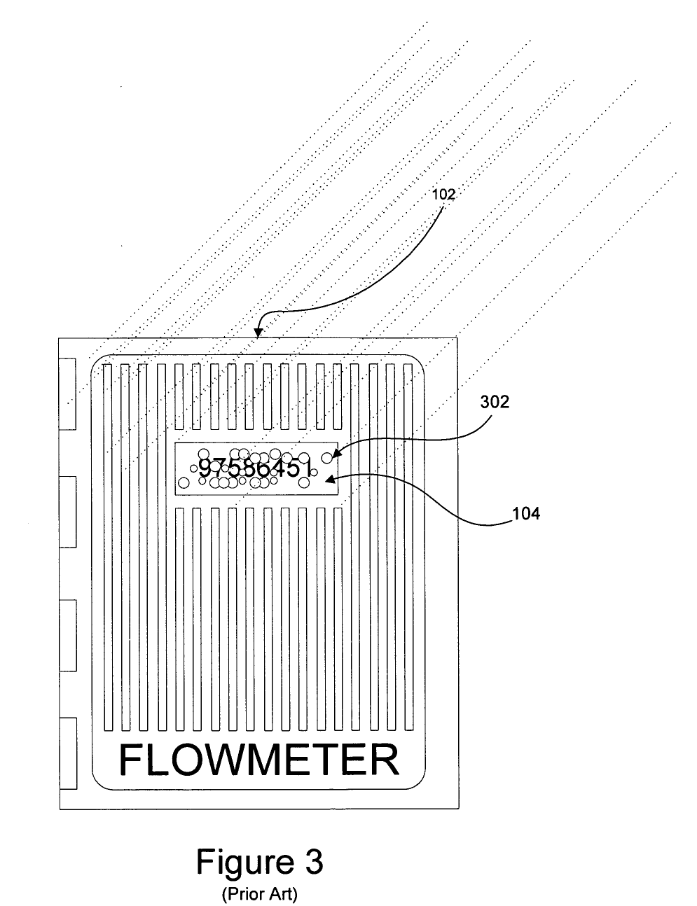

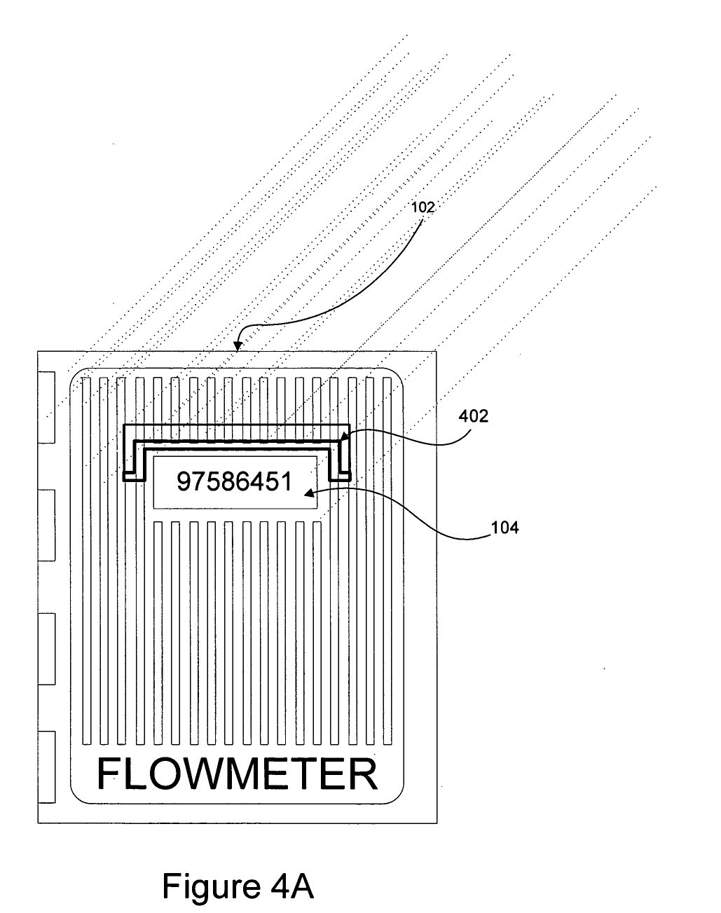

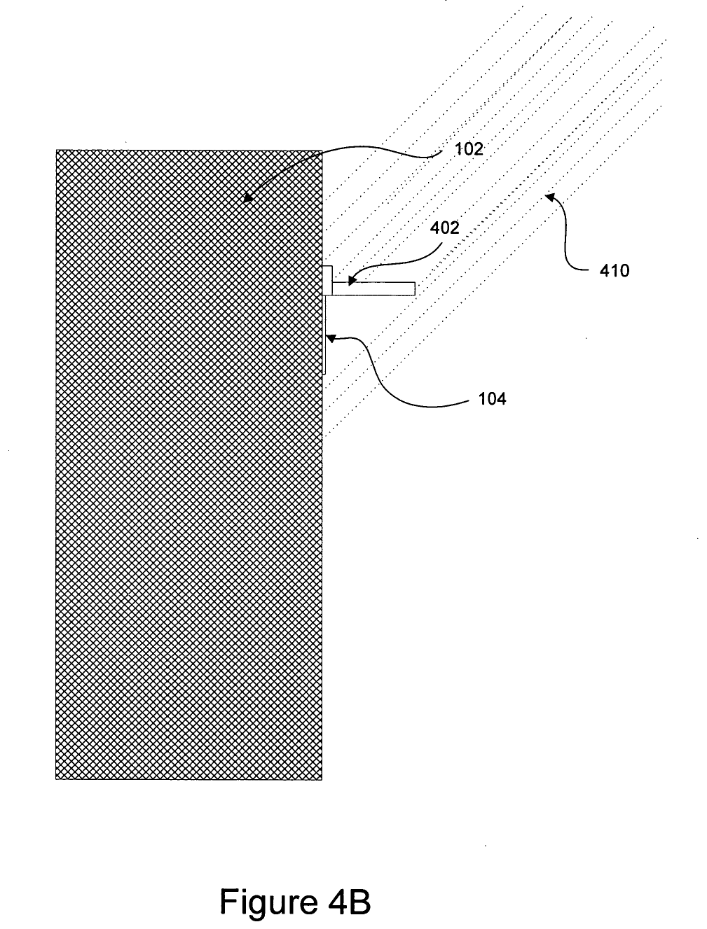

With continuing reference to the figures, and in particular with reference to FIG. 4A, a pictorial diagram illustrating a head on view of an exemplary meter with a meter visor protecting the meter readout (also referred to as a display or meter readout display) is depicted in accordance with one embodiment of the present invention. Meter 102 depicted in FIG. 4A is identical to meter 102 depicted in FIG. 1. However, the display 104 for meter 102 depicted in FIG. 4A is now protected by a meter visor 402.

Meter visor 402 may be constructed of any material from which a rigid or semi-rigid object may be fabricated. Typically the material will be some sort of plastic because of the ease and economics of fabrication. The visor 402 may be clear or colored, the choice of which depends on implementation and particular user preference. However, both clear and colored are equally suitable for preventing rain from striking the meter display 104.

The meter visor 402 may be affixed to the meter 102 via adhesive or mechanical means. For example, the visor 402 may be affixed to the meter 402 with glue or through screws. In other embodiments, the meter visor 402 may be fabricated as part of the overall meter 102 exterior from, for example, a single piece of plastic or metal. However, the particular method for affixing the meter visor 402 to the meter 102 such that the visor 402 provides a covering for the display 104 thereby preventing or inhibiting precipitation from striking and obscuring the display 104 is not critical.

Meter visor 402 extends out away from the front surface of the meter 102 above the display 104. The visor 402 may also wrap around a portion or all of the side of the meter display 104 as well. This extended portion of the meter visor 402 provides a surface that collects particulate matter and precipitation that otherwise would collect on the display 104. Thus, the display 104 remains clear and easy to read by a meter reader.

With reference now to FIG. 4B, a pictorial diagram illustrating a side view of a meter with an exemplary meter visor covering the display is depicted in accordance with one embodiment of the present invention. It is more readily apparent how meter visor 402 protects the display 104 from the elements, such as, for example, the rain 410 depicted in FIG. 4B. The meter visor 402 extends away from the front surface of the meter 102 just above the meter readout 104 similar to the way an eave overhangs the edge of a house or the way the brim or visor of a hat extends from the hat and protects the wearer from sunlight. Thus, the visor 402 provides protection from the elements such that, for example, the rain 410 strikes the top of the meter visor 402 and strikes below the display 104 but does not strike the display 104 due to the presence of the meter visor 402. With the water from the rain kept away from the meter display 104, a meter reader is able to read the meter display 104 more easily than without the visor since there will be little or no water droplets present to obscure the digits on the meter reader.

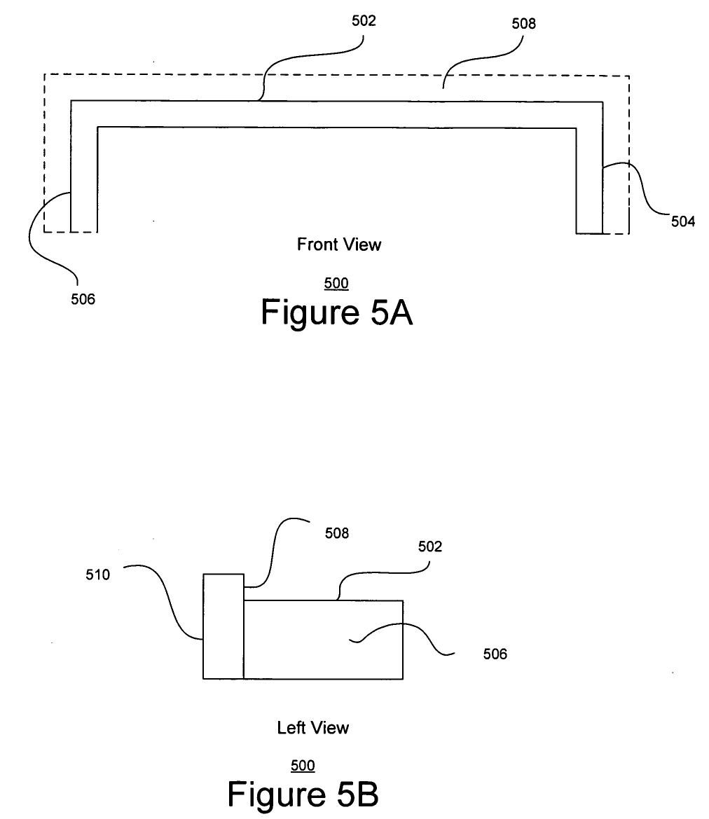

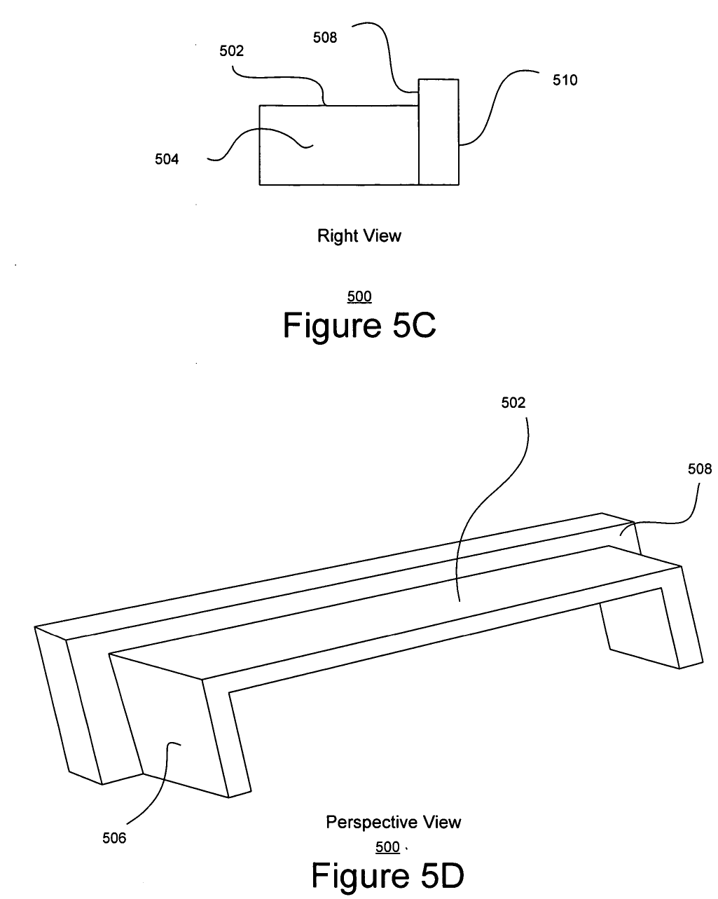

With reference now to FIGS. 5A-5D, schematic diagrams illustrating an exemplary meter visor from various viewpoints are depicted in accordance with one embodiment of the present invention. FIG. 5A shows a front view of an exemplary meter visor 500. FIGS. 5B and 5C show left and right side views respectively of the exemplary meter visor 500 depicted in FIG. 5A. FIG. 5D shows a perspective view of the exemplary meter visor 500 depicted in FIG. 5A.

In this embodiment, the meter visor 500 comprises a top portion 502, a back portion 508, and two side portions 504 and 506. The back portion 508 comprises a thicker portion than the rest of the visor to provide a better surface 510 for affixing the meter visor 500 to a meter. Typically, when a meter is being retrofitted with a meter visor, the meter visor will be equipped with a peel and stick backing on surface 510 to allow someone to take the meter visor to a meter and peel a backing off of surface 510 to reveal a adhesive material such as a glue which will adhere to the surface of a meter. Alternatively, a magnetic backing may be adhered to surface 510 that will allow the meter visor to adhere to a metal surface of a meter if the meter is constructed of a magnetically susceptible metal. As can be seen in FIG. 5A, the side portions 504 and 506 extend down on either side of top portion 508 to help prevent particulate matter or precipitation from striking a meter readout display from a side angle. The top portion 502 and the side portions 504 and 506 extend away from back portion 508 such that when affixed to a meter, the top portion is above the meter readout display and the two side portions 504 and 506 cover at least a part of the meter readout display.

The back portion 508 also provides an extra surface area in which to screw the meter visor 500 onto a meter should it be desirable to use screws as the means for affixing the meter visor 500 to a meter. The meter visor 500 may be constructed from, for example, plastic or metal and may come in any variety of colors or clear. In some embodiments, the meter visor 500 may be colored such that it is opaque to light, thereby helping to block out sunlight from the meter readout display should the glare of the sun cause problems reading the meter readout display. For example, if the meter readout display is a light emitting diode (LED) display, then, if the light amplitude of the LED is not strong enough, strong sunlight could cause the LED display to be difficult or impossible to read by a meter reader from a distance.

It is also possible to attach a small light underneath the top portion 502 such that the light shines on the display for which the meter visor protects. This might be useful in cases in which the meter readout display is a liquid crystal display (LCD) since many such displays require external light to be visible. Having a light under the meter visor 500 top portion 502 could allow the meter readout display to be visible and readable at night. In order to extend the lifetime of the light bulb, the light bulb could be connected to a wireless receiver that allows a user with a remote control to remotely turn on and off the light, thereby preventing overuse of the light. The necessary cables and wiring to implement the light and remote control if utilized could be run from the light under top portion 502 through one of the sides 504 and 506 and then to a battery or other power source (and wireless receiver and switch if utilized) affixed elsewhere to the meter or proximate to the meter. Alternatively, the power supply and/or remote control for the light could be located in the meter itself and appropriate wiring run from the meter to the light situated under the top portion 502. In other embodiments, the light could be affixed to one of the side portions 504 and 506 or to the back portion 508 under top portion 502. Those skilled in the art will recognize that there are many ways to affix a light to meter visor 500 and to power and control the light. Therefore, the embodiments presented here are provided merely as examples and not as limitations to the present invention.

Although meter visor 500 is depicted as having sides that are perfectly (or near perfectly) straight and meeting at right angles, this is not a requirement for a meter visor. In other embodiments, the meter visor may have rounded corners rather than pointed right angle corners where the various surfaces of the meter visor meet. Also, in some embodiments, it may not be necessary to have the additional mass represented by back portion 508 in order to affix the meter visor to a meter. Also, the top portion 502 may be curved or sloped in some embodiments and the sides 504 and 506 may be longer or shorter relative to the top portion 502 in some embodiments. In fact, in some embodiments, the side portions 504 and 506 may not be utilized at all. Furthermore, meter visors are not limited to use with digital readouts but may be utilized with analog readouts as well.

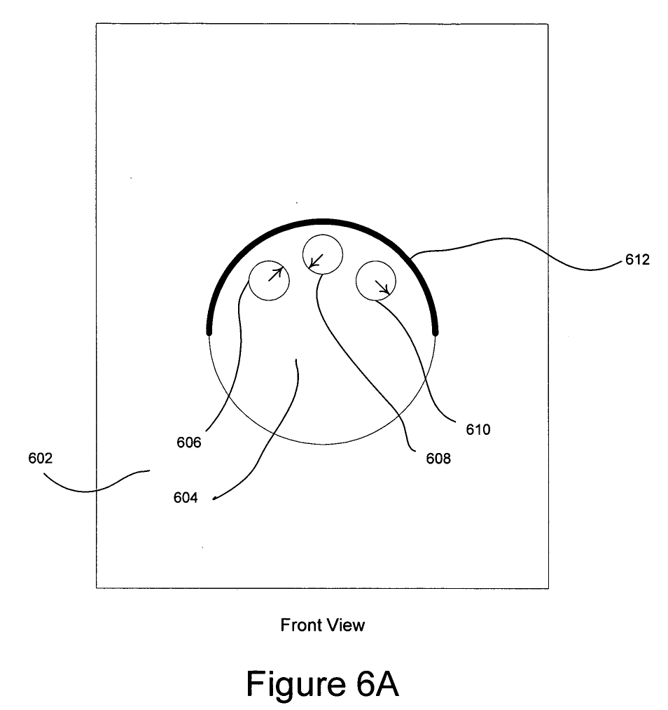

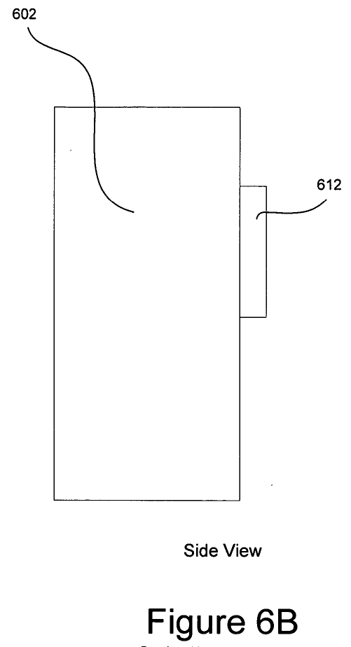

Turning now to FIGS. 6A and 6B, diagrams illustrating a meter having an analog readout and a curved meter visor are depicted in accordance with one embodiment of the present invention. FIG. 6A shows the meter 602 from a front view and FIG. 6B shows the meter 602 from a side view. In this embodiment the meter readout display 604 comprises analog dials 606-610 rather than digital numbers as depicted earlier. The readout 604 is also round in shape. Although it is not required that a curved meter visor be utilized with a round display 604, it may be more desirable in some circumstances. Thus, as an illustration, the meter visor 612 depicted in FIG. 6A is curved such that the one curved section wraps around from one side to the other and over the top of the meter readout display 604 thus protecting both sides and the top of the meter readout display 604 from precipitation and particulate matter. Thus, the meter readout display will be easier to read by a meter reader, for example, during or after a rain shower.

FIG. 6B shows a side view of meter 602 where it is more evident that meter visor 612 extends away from meter 602 to protect the meter readout display 604 which is not visible from this angle.

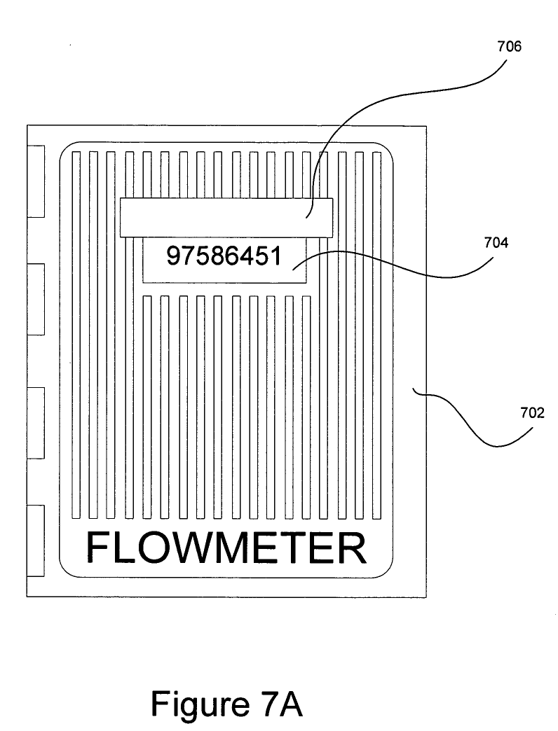

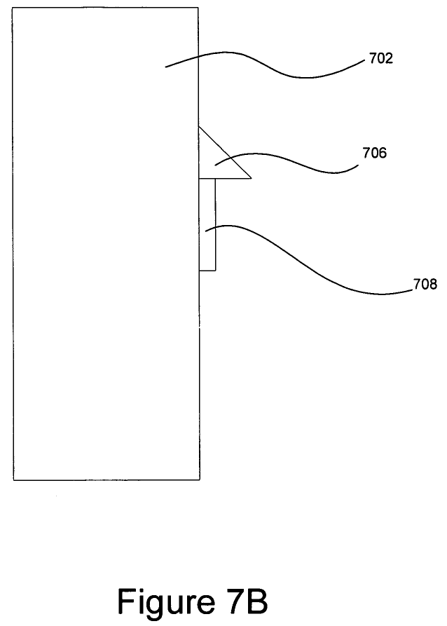

Turning now to FIGS. 7A and 7B, diagrams illustrating a meter with a sloped meter visor protecting the meter readout display are depicted in accordance with one embodiment of the present invention. In this embodiment, the meter visor 706 has a sloping front surface that extends out away from the meter 702 and over meter readout display 704 as is depicted in FIG. 7B.

It should be noted that the particular dimensions of a meter readout may vary by design and are typically selected based on the design and shape of the meter and the meter readout that the meter visor is to be used with. As such, no dimensions are provided herein.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A meter visor for improving the readability of a meter readout, the meter visor comprising:
a first surface configured to extend from a front surface of a meter and to be situated above a meter readout to thereby at least partially protect the meter readout from impact by particles having a trajectory initiated from above the meter readout; and
an adhesive surface proximate to the first surface wherein the first surface and the adhesive surface form an angle at an interface between the first surface and the adhesive surface that is greater than zero and wherein the adhesive surface comprises an adhesive backing which enables the meter visor to be adhesively affixed to the front surface of the meter thereby holding the first surface in place above the meter readout.

2. The meter visor as recited in claim 1, further comprising:
second and third surfaces each extending down from respective opposite ends of the first surface thereby at least partially protecting the meter readout from impact by particles approaching from a side of the meter readout.

3. The meter visor as recited in claim 1, wherein the first surface is approximately perpendicular to the front surface of the meter.

4. The meter visor as recited in claim 1, wherein the first surface is sloped such that the first surface of the meter visor and the front surface of the meter form an acute angle.

5. The meter visor as recited in claim 1, wherein the first surface is curved such that it protects the meter readout from more than one angle of incidence.

6. The meter visor as recited in claim 1, wherein the particles comprise at least one of water droplets, particulate matter, sand, dirt, and light.

7. (canceled)

8. (canceled)

9. The meter visor as recited in claim 1, wherein the first surface is opaque.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The meter visor as recited in claim 1, wherein the adhesive backing comprises a peel and stick backing.

22. The meter visor as recited in claim 1, wherein the adhesive backing comprises glue.
